(19) United States
(12) Patent Application Publication
(10) Pub. No.: US 2012/0121903 A1
(43) Pub. Date: May 17, 2012

(54) AQUEOUS SELF-CROSSLINKABLE POLYMER DISPERSION MADE FROM HARD-CORE, SOFT-SHELL STRUCTURED POLYMER PARTICLES, AND COATING OR TREATMENT COMPOSITIONS

(75) Inventors: Isabelle Betremieux, Coye La Foret (FR); Alain Boone, Verderonne (FR); Jean-Yves Loze, Pontpoint (FR)

(73) Assignee: Arkema France, Colombes (FR)

(21) Appl. No.: 13/386,452

(22) PCT Filed: Jul. 15, 2010
(86) PCT No.: PCT/EP2010/004315

§ 371 Date: Jan. 23, 2012

(30) Foreign Application Priority Data
Jul. 23, 2009 (FR) 09/03667

(51) Int. Cl. C09D 133/12; B32B 5/00; C09D 11/10

(52) U.S. Cl. 428/375; 524/522

(57) ABSTRACT

The present invention relates to an aqueous polymer dispersion, which includes hard/soft Shell structured particles, with the polymer phase of the core P1 having a glass transition temperature Tg1 from 60 to 120° C., the polymer phase of the shell P2 having a glass transition temperature Tg2 from −20 to 40° C., the minimum film-formation temperature MFFT being from 0 to 50° C., with the phase P1 representing from 1.5 to 60% by weight, with respect to the total weight of P1+P2, the phase P1 including at least one monomer M1 having at least two copolymerizable ethylenic unsaturations and at least one ethylenically unsaturated monomer M2 having at least one carboxylic acid and/or anhydride functional group, the phase P2 being from 40 to 85% by weight of the total weight of P1+P2 and with said phase P2 including: at least one monomer M3 selected from the monomers having, in addition to the polymerizable ethylenic unsaturation, at least one group selected from acetoacetoxy, diacetone, methylol or alkoxysilane. The invention also relates to protective and/or decorative coating compositions such as paints, varnishes, transparent coatings, inks or adhesives and fiber treatment compositions.”

The present invention relates to an aqueous specific polymer dispersion, to a polymer dispersion comprising the said dispersion as a mixture with at least one alkyd dispersion and to their uses in coating or treatment compositions.

EP 1 304 343 B1 describes an aqueous polymer dispersion comprising from 10 to 70% by weight of a first polymer with a Tg of between −30° C. and 100° C. and from 30 to 90% by weight of a second polymer with a Tg of between −10° C. and 18° C. According to this document, the dispersions described simultaneously have good film formation at low temperature and a degree of hardness. The monomer composition of the first polymer comprises a multiethylenic monomer and that of the second polymer comprises a “crosslinking” monomer chosen from those carrying acetoacetoxy groups and cyanoacetoxy groups. This document relates to the improvement in the resistance to soiling of paints by rendering the particle a little harder by virtue of inclusions of polymer with a high Tg in the soft polymer. However, improvement in the resistance to blocking of the paint remains fairly low, in particular in the cases exemplified, where the Tg of the hard part is low, remaining less than 13° C.

WO 2005/049184A2 describes an aqueous polymer dispersion obtained by a multistage process. The first stage corresponds to the synthesis of a polymer having a Tg of greater than or equal to 50° C., which polymer comprises, in its monomer composition, a monomer comprising a weak acid group, a monomer comprising a strong acid group and a monomer comprising a ketone group. The second stage corresponds to the synthesis of a polymer having a Tg of between −30° C. and 10° C., which polymer comprises, in its monomer composition, a monomer comprising a weak acid group, a monomer comprising a strong acid group and a monomer comprising a ketone group. According to this description, these dispersions have an MFT of less than 30° C., good film formation, good resistance to high temperature, a high gloss and a good resistance to water and to chemicals. The fact that these two polymer compositions comprise high levels of hydrophilic monomers, such as carboxylic acids, phosphates and diacetone acrylamide, and the fact that they are in addition polymerized at high pH, is a disadvantage with respect to controlling the structure of the particles and the operational performances. This is because this type of composition and this type of process do not make possible a clear distinction from the hydrophilicity of the hard part with respect to that of the soft part, thus resulting in a random structure of the polymer particles. The risk of this type of particle morphology is that of resulting in heterogeneous and uncontrolled film formation and thus in certain failings, such as poor reproducibility of the elongation properties of the paint film or a fairly high roughness of the varnish film.

There is thus a need, with respect to this state of the art, for novel dispersions which easily form films without a coalescence agent, resulting in the achievement of homogeneous films with an MFFT obtained which is well managed and representative of the specific structure of the hard core/soft shell polymer particle, dispersions which are also stable, both during the polymerization and during prolonged storage before use, no change over more than 3 months of storage at 50° C., with good reproducibility of the characteristics. Furthermore, these novel dispersions are self-crosslinkable and behave as single-component crosslinkable compositions, type 1K, during film formation and the departure of the water, giving transparent (homogeneous) films free from failings in terms of structure and of performance and thus making it possible to obtain coatings having a high gloss, good chemical resistance, good wet adhesion, good flexibility and also excellent resistance to blocking (good even at higher temperature), and a high hardness. More particularly still, there is a need for aqueous polymer dispersions having good compatibility with specific polymers and more particularly with alkyds. These specific dispersions, as a mixture with alkyd dispersions, thus make possible the additional improvement in the gloss, in the resistance to water, in the hardness and in the rate of drying with the achievement of a satisfactory resistance to blocking very rapidly after film formation.

More particularly, the objective of the invention is the achievement, by a specific process, of a dispersion having particles structured as a hard core/soft shell with such a structure being well managed and reproducible in terms of structure and performance, which means that the hard and soft phases are organized according to a perfectly reproducible core and shell geometry. This structure, because it is truly obtained, makes it possible to have structured particles which form perfect films, even with very little coalescence agent, by virtue of the soft shell which completely covers the hard core. The excellent film formation (reproducible and homogeneous) thus makes it possible to obtain specific properties of gloss, chemical resistance, adhesion and flexibility. Furthermore, the managed structure of the hard core reproducibly provides the properties of hardness and of resistance to blocking. This perfectly managed structure thus results in a compromise in properties at a level entirely exceptional and unmatched to date because the core and the shell of the particle are managed by the control of the specific compositions and of a specific process used. Given that the objective was to control the hard core/soft shell structure, the process which has been chosen is a direct process, with the core of the particle being obtained before the shell, in the order of addition of the corresponding compositions, thus making it possible to obtain the structure by virtue of the synthesis and the kinetics and not by virtue of a thermodynamic equilibrium (reverse diffusion of one phase into the other by chemical affinity). In the latter case, often chosen for reasons of simplicity, the final structure is based on a thermodynamic equilibrium and the kinetics for obtaining the equilibrium and the nature of the equilibrium are difficult to manage and to reproduce. In such a case, this results in latexes having properties which vary, in particular the film formation and thus all the other properties mentioned beforehand and which are directly related to the film formation. Consequently, a very simple way of confirming that the particle is well managed with regard to targeted and stable structure is to measure the minimum film-formation temperature. Thus, in the case of the present invention, due to the excellent management of the structure, the MFFT is predictable, reproducible and stable. The dispersion as defined according to the present invention thus makes it possible to first satisfy these general requirements and subsequently, some more specific forms of the invention, additionally satisfy more particular technical requirements more specifically targeted by these preferred forms of the invention.

Thus, the first subject matter of the present invention relates to an aqueous polymer dispersion, structured as regards the structure of the particles formed of polymer as a core/shell structure, with said core being hard and said shell being soft, with a specific composition and specific characteristics for each polymer corresponding to the core P1 and to the shell P2. A specific process for the preparation of said aqueous dispersion also comes within the subject matters of the present invention.

A second subject matter of the more specific aqueous dispersion of the present invention is an aqueous polymer dispersion which comprises at least one dispersion as defined in the first subject matter of the present invention and, in addition, at least one second nonstructured polymer dispersion, said polymer being selected from several reactive or unreactive polymers and more particularly from polyesters, more particularly unsaturated polyesters, and more preferably still alkyds, polyamides or polyurethanes.

Another subject matter of the invention relates to a coating or treatment composition comprising at least one dispersion of the invention as defined according to the first or the second subject matter defined above. It relates in particular to protective and/or decorative coating compositions from paints, varnishes, transparent coatings, inks or adhesives and treatment compositions for fibers.

Another subject matter of the invention relates to the use of dispersions defined according to the present invention in coatings, more particularly protective and/or decorative coatings, or the treatment of fibers.

The final subject matter of the invention relate respectively to a substrate coated starting from a coating composition according to the invention and a fiber treated with a treatment composition, the two compositions respectively comprising at least one dispersion as defined according to the invention.

Thus, the first subject matter of the present invention is an aqueous polymer dispersion comprising particles structured as a hard/soft core/shell, with the following specific characteristics:
the polymer phase of the core P1 has a glass transition temperature Tg1 from 60 to 120° C. and preferably from 60 to 100° C., and the polymer phase of the shell P2 has a glass transition temperature Tg2 from −20 to 40° C. and preferably from −15 to 30° C., and said dispersion exhibits a minimum film-formation temperature MFFT from 0 to 50° C. and preferably from 0 to 40° C.,
the phase P1 represents from 15 to 60% by weight, preferably from 20 to 60% by weight and more preferably from 20 to 55% by weight, with respect to the total weight of monomers of said dispersion (that is to say, total weight of P1+P2), and
the phase P1 comprises at least one monomer M1 having at least two copolymerizable ethylenic unsaturations, more particularly having a crosslinking agent role, and at least one ethylenically unsaturated monomer M2 carrying at least one carboxylic acid and/or anhydride functional group,
the phase P2 represents from 40 to 85% by weight, preferably from 40 to 80% by weight and more preferably from 45 to 80% by weight of the total weight of the monomers of said dispersion, and
said phase P2 comprises:
at least one monomer M3 selected from the monomers carrying, in addition to the polymerizable ethylenic unsaturation, at least one group selected from acetoacetoxy, such as carried by acetoacetoxyethyl(meth)acrylate (AAEM), diacetone, such as carried by diacetone acrylamide (DAAM), methylol, such as carried by N-methylolacrylamide (NMA), or alkoxysilane, such as carried by alkoxysilyl(meth)acrylates, with DAAM, NMA, AAEM and alkoxysilyl(meth)acrylates as preferred monomers M3. In the case where the monomer M3 carries an acetoacetoxy group, the post-polymerization addition of a water-soluble or water-dispersible component carrying at least two functional groups of amine or hydrazide type can be used and similarly, in the case where the monomer M3 carries a diacetone group, a water-soluble or water-dispersible C₄, C₆ or C₈ component can be used, which component carries at least two hydrazide functional groups, such as adipic acid dihydrazide, in order to be able to crosslink the dispersion during film formation by elimination of water.

Preferably, said phase P2 also comprises at least one transfer agent selected from hydrophilic mercaptans or mercaptans carrying an ionic group.

In fact, said acetoxy, diacetone, methylol or alkoxysilane groups of said monomers M3 provide said dispersion of the invention with a character of self-crosslinkable dispersion behaving as a 1K system (single-component self-crosslinkable system), in post-polymerization, during the stage of film formation-drying, the self-crosslinking being promoted by the departure of the water and of the neutralizing agent during said drying in the course of film formation.

More particularly, said polymer phase P1 is composed of a seed polymer phase P0 and of a complementary polymer phase P′1, meaning complementary to P0 to give P1, with the composition of said phase P0 being devoid of said monomers M1 and M2 and, with regard to the remainder (apart from M1 and M2), it being possible for the compositions of P0 and P′1 to be identical or different.

Preferably, said phase P2 comprises at least one second transfer agent selected from hydrophobic mercaptans, with the ratio by weight of hydrophilic agent to hydrophobic agent being greater than 1 and preferably greater than 1.5. The overall content by weight of said first and second transfer agents represents from 0.02 to 2% and preferably from 0.05 to 1.5%, with respect to the total weight of monomers of said dispersion (total weight of the phases P1+P2). With respect to P2, this % by weight varies from 0.02 to 5% and preferably from 0.05 to 4%.

More preferably, when the content by weight of P1 exceeds 35%, preferably 30%, said Tg1 in this case remains below 75° C.

Said Tg1 and Tg2 terms, as defined in the present invention, are determined by calculation according to Fox relationship and, in this calculation, the potential presence is taken into account of plasticizer or of any compound, including residual monomers, which can play such a role and can thus affect the Tg of the polymer.

The difference between said Tg1 and Tg2 values thus calculated preferably varies from 20 to 140° C. and preferably from 30 to 115° C.

The monomer M1 of the phase P1 can be chosen from monofunctional or polyfunctional allyl ester monomers derived from α,β-unsaturated carboxylic or dicarboxylic acids (such as allyl(meth)acrylate, monoallyl or diallyl maleate or monoallyl or diallyl tetrahydrophthalate) or polyfunctional allyl esters of saturated di- or polycarboxylic acids (such as diallyl phthalate or triallyl trimellitate) or other polyallyl monomers (such as triallyl cyanurate), polyfunctional (meth)acrylic esters with a functionality of at least 2, such as polyalkylene glycol di(meth)acrylates (such as ethylene glycol di(meth)acrylate, tripropylene glycol di(meth)acrylate or diethylene glycol di(meth)acrylate), alkylene diol or polyol di(meth)acrylates, preferably with alkylene ranging from C₂ to C₈ (such as 1,6-hexanediol di(meth)acrylate, 1,3-butylene glycol di(meth)acrylate, 1,4-butanediol di(meth)acrylate, neopentyl glycol di(meth)acrylate or trimethylolpropane tri(meth)acrylate), and polyvinylbenzenes (such as divinylbenzenes, divinyltoluenes, divinylnaphthalenes or trivinylbenzene). Those preferred are allyl(meth)acrylates, butanediol di(meth)acrylates or hexanediol di(meth)acrylate.

The monomer M2 of the phase P1 can be chosen from (meth)acrylic, fumaric, maleic, itaconic, vinylbenzoic, crotonic or isocrotonic acids and/or their anhydrides and preferably methacrylic acid (MAA) and/or acrylic acid (AA). AA and MAA are the most preferred.

More particularly, said monomers M1 and M2 of the phase P1 represent an overall content by weight ranging from 0.5 to 10% and preferably from 1 to 8% of the total weight of the phase P1, with said monomer M2 representing from 0.1 to 5% by weight and preferably from 0.2 to 4% by weight of said phase P1.

In the dispersion according to the invention, the phase P2 also, like P1, comprises at least one monomer M2 as defined above, with respective contents of M2 in the phases P1 and P2 such that the ratio of the content of M2 in P1 to that in P2 varies from 1/1 to 1/10 and preferably from 1/2 to 1/8.

Said monomer M3 can be present in said phase P2 at a content by weight ranging from 1 to 25% and preferably from 1 to 15%, expressed with respect to the total weight of P1+P2, more particularly with a %, expressed with respect to P2, ranging from 1 to 60% and preferably from 1.5 to 40%.

According to a more preferred form of the present invention, said monomer M3 carries a diacetone group and said dispersion additionally comprises in the dispersed form, adipic acid dihydrazide, which is added to the dispersion at the end of the polymerization of P1 and P2, before or after the addition of the neutralizing agent.

According to a more preferred form of the present invention, said monomer M3 carries an acetoacetoxy group, which is quantitatively converted into the enamine group masked form, this being done at the end of the polymerization of P1 and P2.

According to a more preferred form of the present invention, said monomer M3 carries an acetoacetoxy group, which is quantitatively converted into the enamine group masked form, this being done in situ during the polymerization corresponding to (the production of) the phase P2, said phase P2 being, in such a case, devoid of any monomer M2 as defined above.

According to a yet more specific form, said phase P1 can also comprise (in addition to P2) at least one monomer M3 carrying an acetoacetoxy group. More particularly still in this case, said acetoacetoxy group of the phase P1 can be quantitatively converted into the enamine masked form, this taking place during the polymerization corresponding to (the production of) the phase P2. In fact, the conversion to enamine in the phase P1 is obtained in this case after the polymerization corresponding to the production of the phase P1.

In the dispersion of the invention, said phase P2 can comprise, in addition to the monomers M2 and/or M3, at least one other (that is to say different) monomer M4 carrying, in addition to the polymerizable ethylenic unsaturation, at least one functional group selected from: hydroxyl, such as carried by hydroxyalkyl (meth)acrylates with alkyl from C2 to C4 (such as HEMA or HPMA), amine, such as carried by aminoalkyl(meth)acrylates or aminoalkyl(meth)acrylamides, for example DAMEMA (dimethylaminoethyl methacrylate) or TBAEMA (t-butylaminoethyl methacrylate), oxirane, such as carried by glycidyl(meth)acrylate (such as GLYMA), phosphates, phosphonates or phosphinates, such as carried by phosphates or phosphonates or phosphinates of hydroxylalkyl(meth)acrylates and ethoxylated and/or propoxylated hydroxyalkyl(meth)acrylates, amide, such as (meth)acrylamide, sulfate and sulfonate, such as carried by (meth)acrylates of hydroxyalkylsulfonates (such as the methacrylate of hydroxyethylsulfonate) or (meth)acrylamides of hydroxyalkylsulfonates (such as acrylamidopropanesulfonic acid) and their salts, imide, such as maleimide, aziridine, such as carried by the methacrylate of 1-(2-hydroxyethyl)aziridine, oxazoline or imidazole, such as carried by 2-(2-oxoimidazolidin-1-yl)ethyl methacrylate, provided that the choice of the monomers M4 is made so as to avoid a reaction or an ionic interaction during the synthesis which would render the latter impossible between the various groups of the monomers M4 or between the groups of the monomers M4 and the groups of the other monomers.

Said phase P2 can comprise, in addition to these monomers (M2 and/or M3 and/or M4), at least one other (that is to say different) monomer M5 selected from at least one oil (glycerol esters) of unsaturated C₁₀ to C₃₆ fatty acids (including dimers) and/or at least one methyl ester corresponding to these fatty acids, preferably at least one linseed oil and/or at least one methyl ester of linoleic acid and/or linolenic acid.

According to a preferred form of the invention, said phase P2 of the dispersion of the present invention comprises both the monomer M3 and the monomer M5 as defined above.

As regards the monomer structure (or monomer composition) of the phases P1 and P2, they can either be based on purely acrylic monomers and thus on a pure acrylic structure (“acrylic” here meaning both acrylic and/or methacrylic) or else based on a mixed structure which can comprise, in one of the two phases (P1 or P2) or in both phases, vinylaromatic monomers, more particularly styrene and/or its derivatives, such as vinyltoluenes or else vinylbenzene, or/and preferably styrene and/or vinyltoluenes. More particularly, P1 and/or P2 can comprise such vinylaromatic monomers. According to another alternative form, the phase P1 alone is purely acrylic and, according to another alternative form, the phase P2 alone is purely acrylic and, according to a third alternative form, the two phases P1 and P2 are purely acrylic and thus consequently said dispersion is also purely acrylic.

According to another alternative form of the dispersion of the present invention, the phase P2 comprises vinylaromatic monomers and the phase P1 is purely acrylic and, according to another alternative form, the phase P2 is purely acrylic and the phase P1 comprises vinylaromatic monomers as defined above. The most preferred alternative forms of the dispersion of the invention correspond to: a phase P2 comprising vinylaromatic monomers with a phase P2 being purely acrylic, the dispersion being, in this case, of styrene/acrylic type, and a dispersion which (P1 and P2) is purely acrylic.

Said phase P1 can comprise and preferably comprises a seed phase P0, devoid of monomers M1 and M2 as defined above, with said phase P0 representing from 2 to 25% by weight and preferably from 5 to 20% by weight of the weight of said phase P1. More particularly, the phase P1 is obtained before said phase P2, which phase P2 is obtained by polymerization of the monomers corresponding to this polymer phase, at a temperature below or equal to and preferably below Tg1 as defined above. More preferably still, the temperature (for the polymerization of P2) is at least 5 degrees below Tg1.

The dispersion of the invention as described above can be obtained by emulsion polymerization, comprising (that is to say in the presence of) a seed P0, and with the following specific additional characteristics:
said seed P0 comprises from 0.1 to 1.5% by weight and preferably from 0.3 to 1.2% by weight, expressed with respect to the total weight of P1+P2, of at least one anionic surfactant
the phase P1 comprises from 0.1 to 3% by weight and preferably from 0.1 to 1.5% by weight of the total weight of P1+P2 of at least one anionic surfactant which can be the same or different from that of the seed P0, with optionally the possibility of a second anionic surfactant different from the first, with the content by weight of these two anionic surfactants of P1 remaining from 0.1 to 3% and preferably from 0.1 to 1.5% of the total weight of P1+P2
the phase P2 comprises from 0.1 to 3% by weight and preferably from 0.2 to 2.5% by weight, with respect to the total weight of P1+P2, of at least two surfactants:
a) the first being nonionic and chosen from alkoxylated fatty alcohols, preferably alkoxylated C₁₂ to C₁₆ fatty alcohols, with the preferred alkoxy units being ethoxy and/or propoxy units and more preferably ethoxy units, the number of said alkoxy units preferably being from 3 to 50 and more preferably from 5 to 40 ethoxy units
b) the second being anionic, being able to be identical to or different from that defined for P0.

The unspecified anionic surfactant can be chosen from sulfates or sulfonates or phosphates or phosphonates of C₉ to C₁₄ fatty alcohols which are optionally alkoxylated with, as alkoxy units, ethoxy and/or propoxy, ethoxy being the more preferred alkoxy unit, and with a preferred number of alkoxy units ranging from 2 to 30 and preferably from 2 to 10, said anionic surfactant preferably being selected from dodecylbenzenesulfonate, sodium lauryl sulfate, ethoxylated sodium lauryl sulfate, ethoxylated sodium isotridecyl sulfate, ethoxylated ammonium lauryl phosphate or sulfosuccinate.

The choice may be made, as nonionic surfactant, from alkoxylated fatty alcohols, preferably alkoxylated C₁₂ to C₁₆ fatty alcohols, with the preferred alkoxy units being ethoxy and/or propoxy units and more preferably ethoxy units, the number of said alkoxy units preferably being from 3 to 50 and more preferably from 5 to 40 ethoxy units.

More specifically, the process for the preparation of a dispersion as defined according to the invention comprises at least the three following stages:
i) a seeding stage comprising a prepolymerization (partial or complete) of a seed composition P0 devoid of monomers M1 and M2 and with seed particles having a size of less than or equal to 30 nm, and representing a content by weight ranging from 2 to 25% and preferably from 5 to 20%, with respect to the weight of said phase P1,
ii) a stage of polymerization of a monomer composition P′1 comprising said monomers M1 and M2 and giving the polymer phase P′1, thus constituting, with the seed polymer P0 obtained in stage i), said polymer phase P1 of the core of the particle, it being possible for said monomer composition P′1, apart from the presence of the monomers M1 and M2, to be identical to or different from that of the seed composition P0,
iii) a stage of polymerization of a monomer composition P2, giving rise to said phase P2.

The initiators of the seeding stage (i) represent a content by weight of from 0.1 to 4% of the total weight of P1+P2.

As regards the temperature ranges used in this process:
stage i), like stage ii), is carried out at a temperature of 75 to 90° C.
the polymerization stage iii) is carried out at a temperature below or equal to Tg1 and preferably below Tg1, and more preferably below by at least 5 degrees with respect to Tg1, this being the case for a process at atmospheric pressure.

According to a preferred form of the process, stage ii) of emulsion polymerization of the monomer composition P′1 (and preferably P1) is continued up to a degree of conversion of at least 95%, before addition of the monomer composition P2.

The second subject matter of more specific aqueous dispersion according to the invention is an aqueous polymer dispersion which comprises, in addition to a (at least one) first aqueous polymer dispersion as defined above, at least one other second aqueous polymer dispersion (or dispersion of water-dispersible resins), preferably based on saturated and/or unsaturated polyester resins and more particularly on alkyd resins, more particularly still modified alkyd resins, such as acrylic-modified alkyd resins, or alkyd resins modified by styrene or by urethane or by oxidizing treatment, or based on acrylic copolymers, or based on acrylated acrylic oligomers, or based on polyurethanes, or based on hydrocarbon resins, such as aliphatic C₅ or aromatic C₉ or mixed C₅/C₉ hydrocarbon resins. More preferably, said dispersion according to the invention comprises, in addition to a (at least one) aqueous dispersion as defined according to the first subject matter of the invention defined above, at least one other (second) polymer dispersion which is based on at least one alkyd resin as defined above (modified or unmodified and, in the case where it is modified: acrylic-, styrene-, urethane- or amide-modified or modified by oxidizing treatment). According to the latter preferred case, said aqueous dispersion comprises an alkyd dispersion (or dispersion of alkyd resin) with a content by weight of said alkyd resin representing from 15 to 45% by weight of the total weight of the alkyd and of the other polymer of the dispersion as defined according to the first subject matter of the invention above (said other polymer of the dispersion corresponding to P1+P2). This content varies in a range extending from 15 to 85%, with respect to the total weight of the P1+P2 monomers.

According to a more preferred form, said aqueous dispersion, as defined above as second subject matter of specific dispersion of the invention, comprises, as polymer dispersion (defined as first subject matter of the invention), at least one aqueous dispersion comprising at least one monomer M5 chosen from at least one oil (glycerol ester) of at least one unsaturated C₁₀ to C₃₆ fatty acid and/or at least one methyl ester corresponding to these fatty acids and more preferably at least one linseed oil and/or one methyl ester of linoleic acid and/or linolenic acid. The modification by such a monomer M5 of the polymer dispersion defined as first subject matter of the invention contributes to substantially improving the chemical resistance, the resistance to blocking and the compatibility and adhesion of the film of said dispersion with an alkyd coating, applied either after or before said film to the same substrate to be protected and/or decorated.

Said dispersion, as defined as second subject matter of more specific dispersion of the invention, has the advantage of being able to be prepared by simple mixing of at least one other aqueous polymer dispersion or aqueous resin dispersion as already defined above and preferably by simple mixing of at least one aqueous alkyd dispersion with at least one aqueous dispersion as defined as first subject matter of the present invention.

Another subject matter of the invention relates to a coating composition or a treatment composition which comprises at least one aqueous dispersion as already defined above according to the second subject matter of the invention.

According to a first possibility, said coating composition is a protective and/or decorative coating composition and it is preferably selected from paints, varnishes, transparent coatings, inks or adhesives.

Preferably, the treatment composition is a composition for the treatment of fibers, which can be natural or synthetic and organic or inorganic and can be in the form of isolated fibers or in the form of a mat or of woven or nonwoven fabrics. Mention may be made, as examples of fibers, of fibers of glass, carbon, textile or aramid, such as Kevlar®.

Another subject matter of the invention relates to the use of an aqueous dispersion as defined according to the first subject matter or as defined according to the second subject matter of the present invention, which subject matters are defined above and below, in protective and/or decorative coatings or in the treatment of fibers.

The use of said dispersions according to the invention in the coatings more particularly relates to the protection and/or decoration of substrates, preferably selected from wood, board, metal, plastic, plaster, concrete, fiber-reinforced cement or glass.

Said use in the treatment of glass fibers and textile fibers can be carried out with said fibers in the form of woven or nonwoven fibers.

Another subject matter of the invention relates to a coating obtained by the use of at least one dispersion as defined according to the first or the second subject matter of dispersion of the present invention or by the use of a coating composition as defined above according to the present invention.

Finally, first a substrate coated with at least one layer of at least one coating composition as defined above according to the invention and subsequently a fiber treated with at least one treatment composition as defined above according to the present invention also come within the invention.

The examples below in the experimental part, without in any way limiting the scope of the invention, are presented in order to give a better illustration of the present invention, its performance and technical advantages.

### Experimental Part

### A) Description of Starting Materials, of the Preparation of the Dispersions and Applicational Formulations and of Tests Used

### 1) Starting Materials for the Preparation of the Dispersions (See Table 1 Below)

TABLE 1
Starting materials used in the synthesis of the dispersions

| Constituents | Roles | Chemical natures | Suppliers |
|---|---|---|---|
| Aerosol^{R} A102 | Surfactant | Ethoxylated fatty alcohol (C₁₀-C₁₂) | Cytec |
| | | sulfosuccinate, | |
| | | sodium salt, | |
| | | 30% solution in water | |
| Disponil^{R} FES | Surfactant | Fatty alcohol polyglycol ether | Cognis |
| 32 | | sulfate, | |
| | | sodium salt, | |
| | | 31% solution in water | |
| Tergitol^{R} 15S9 | Surfactant | Ethoxylated secondary fatty alcohol | Dow |
| | | with 9 EO, 100% | |
| HDDA | Crosslinking | Hexanediol diacrylate (HDDA) | Sartomer |
| | agent | | |
| BuA | Monomer | Butyl acrylate | Arkema |
| MMA | Monomer | Methyl methacrylate | Arkema |
| AA | Monomer | Acrylic acid | Arkema |
| AAEM | Crosslinking | Acetoacetoxyethyl methacrylate | Huntsman |
| | agent | | |
| Radia^{R} 7061 | — | Linseed oil methyl ester | Oleon |
| nDDM | Mercaptan | n-Dodecyl mercaptan | Acros |
| MPP | Mercaptan | Mercaptopropionic acid | Acros |
| Na₂S₂O₈ | Peroxide | Sodium persulfate | Aldrich |
| Na₂S₂O₅ | Reducing agent | Sodium metabisulfite | Prolabo |
| TBHP | Peroxide | 70% tert-Butyl hydroperoxide | Aldrich |
| SFS | Reducing agent | Sodium formaldehydesulfoxylate | Bruggeman |
| NaOH | Neutralization | Sodium hydroxide | Prolabo |
| Acticide^{R} MBS | Biocide | Aqueous solution of | Thor |
| | | methylisothiazoline (MIT) and | |
| | | benzisothiazolinone (BIT) | |
| | | (2.5% MIT/2.5% BIT) | |

### 2) Procedure for the Preparation of the Dispersions Studied Here

The procedure described below describes the synthesis of the dispersion according to example 1. It remains the same for the other dispersions of the other examples described in this patent apart from the modifications indicated for compositions or other parameters. Specifically:

The amounts of monomers M1 and M2 in P1 and those of M2 and M3 in P2 remain unchanged with respect to the combined P1+P2 monomers (with regard to 100 p of P1+P2 monomers), in all the examples.

Subsequently, the Tg values of the core (Tg1) and of the shell (Tg2) are adjusted by varying the ratio by weight of methyl methacrylate and butyl acrylate present in each of the phases P1 and P2 according to Fox law and so as to obtain, with the other monomers present, the percentage by total weight of each of the phases P1 and P2, their sum coming to 100.

### Equipment Used:

A 3 1 (internal capacity) glass reactor provided with a jacket and equipped with efficient stirring (vortex), with a three-flow reflux condenser and with control and regulation of the material temperature. The reactor comprises the number of inlets necessary for the separate introduction of the various components and also an inlet dedicated to rendering the assembly inert with nitrogen. Leaktightness is confirmed before each synthesis. The apparatus is equipped with a system which makes it possible to control the flow rates for the introduction of the components.

### Preparation of the Vessel Heel Initial Charge:

12 g of Disponil FES 32 are dissolved in 1016 g of demineralized water as vessel heel. The temperature of the vessel heel is brought to 85° C.

### Preparation of the Seed P0:

19.5 g of MMA and 19.5 g of BuA are mixed.

### Preparation of the Preemulsion P′1:

12 g of Aerosol A102 and 24 g of Disponil FES 32 are dispersed in 95 g of demineralized water with good stirring.

The following are added in turn and with good stirring:
264.2 g of MMA
15 g of BuA
12 g of HDDA
6 g of AA

The preemulsion thus formed is white and stable and it will be kept gently stirred.

It will be used for the synthesis of the core of the particle, P1, composed of P0 and P′1 (P1=P0+P′1).

### Preparation of the Preemulsion P2:

12 g of Aerosol A102 and 6 g of Tergitol 15S9 are dispersed in 171.7 g of water with good stirring.

The following are added in turn and with stirring:
318.3 g of MMA
408.3 g of BuA

A white and stable preemulsion is obtained.

10% of this preemulsion, i.e. 91.6 g, will be withdrawn and used to carry out a seeding before running in P2.

The following are then added to the preemulsion, still with good stirring:
120 g of AAEM
18 g of AA
1.2 g of MPP

This white and stable preemulsion, P2, will be used for the synthesis of the shell of the particle.

### Preparation of the Solutions of Catalysts:

4.2 g of sodium persulfate are dissolved in 80 g of water.

1:2 g of sodium metabisulfite are dissolved in 10.8 g of water.

1 g of TBHP (70%) is dissolved in 4.5 g of water.

0.5 g of SFS is dissolved in 11.5 g of water.

### Polymerization Process:

### i) P0 Seeding

The vessel heel with the initial charge, being stable in temperature at 85° C., are then introduced for the P0 seeding, the mixture of 19.5 g of MMA and 19.5 g of BuA. Once the temperature has stabilized, 70% of the sodium persulfate solution are added. The exothermicity maximum marks the end of this stage, the particle size is approximately 30 nm and the conversion is greater than 70%.

### ii) Synthesis of the Core P1

The introduction of the preemulsion P′1 lasts 90 minutes, at a polymerization temperature of 85° C.

iii) Stage of Thermal Curing and Cooling

The temperature is maintained at 85° C. for 60 minutes. At the end of the thermal curing, the reaction medium is cooled to 65° C. The conversion is then approximately 100%.

### iv) Synthesis of the Shell P2

The seed composed of 91.6 g of the P2 fraction is introduced into the reactor at 65° C. Mixing is carried out for at least 5 min.

Beginning of the separate introductions:
of 100% of the second preemulsion P2 (after seeding)
30% of the initiator solution
100% of the activator solution

While the materials are being run in, which lasts 150 minutes, the temperature of the medium is maintained at 65° C. This stage is followed by a postcuring at 65° C. lasting 30 minutes.

### v) Redox Treatment

The TBHP and SFS solutions are added at 65° C. over 30 minutes. This redox treatment is followed by a curing at 65° C. for 30 minutes before cooling to ambient temperature.

### vi) Final Additions

The latex is neutralized at 30-35° C. by addition of sodium hydroxide solution to pH 8 and a biocide is subsequently added. The latex is subsequently filtered through a 100 μm cloth. The solids content is 41.5%.

The final particle size is approximately 90 nm, the viscosity is less than 100 mPa·s and the measured MFFT is 5° C.

The list of the various aqueous dispersions prepared on the basis of this procedure is presented in table 2 below, with the parameters which vary from one test to another being indicated.

### 3) Dispersions Prepared and Variable Characteristics (See Table 2 Below)

TABLE 2
Dispersions prepared

| | | | | Tg | Tg | Tg P1 | Tg P2 | Mean | |
|---|---|---|---|---|---|---|---|---|---|
| | | | % P1/ | P0 | P′1 | Tg1 | Tg2 | Tg | |
| No. | % P0 | % P′1 | % P2 | (° C.) | (° C.) | (° C.) | (° C.) | (° C.) | Comments |
| 1 | 3.25 | 24.75 | 28/72 | 4 | 91 | 79 | 0 | 18 | According to |
| | | | | | | | | | the invention |
| 2 | 3.25 | 36.75 | 40/60 | 4 | 70 | 64 | −15 | 12 | According to |
| | | | | | | | | | the invention |
| 3 | 3.25 | 24.75 | 28/72 | 4 | 92 | 79 | 0 | 18 | Comparative |
| | | | | | | | | | P1 without M1 |
| 4 | 3.25 | 24.75 | 28/72 | 4 | 91 | 79 | 0 | 18 | Comparative |
| | | | | | | | | | P1 without M2 |
| 5 | 3.25 | 24.75 | 28/72 | 4 | 92 | 79 | 0 | 18 | Comparative |
| | | | | | | | | | P1 without M1 |
| | | | | | | | | | or M2 |
| 6 | 3.5 | 36.5 | 40/60 | 70 | 71 | 71 | −10 | 17 | According to |
| | | | | | | | | | the invention |
| 7 | 3.5 | 36.5 | 40/60 | 70 | 71 | 71 | −10 | 17 | According to the |
| | | | | | | | | | invention (M5 |
| | | | | | | | | | effect): addition |
| | | | | | | | | | of Radia^{R} 7061 |
| | | | | | | | | | to P2 |

In example 7, the amount of Radia 7061 introduced during the synthesis of the shell (P2) is 2%, with respect to the P1+P2 total weight.

The Tg values of the phases are calculated according to the Fox law from the Tg values of the homopolymers indicated as below:

| Monomer | Abbreviation | Tg (° C.) |
|---|---|---|
| Acrylic acid | AA | 106 |
| Methacrylic acid | MAA | 228 |
| Butyl acrylate | BuA | −54 |
| Acetoacetoxyethyl methacrylate | AAEM | 18 |
| Methyl methacrylate | MMA | 105 |

### 4): Physicochemical Characterization of the Dispersions

### a) Solids Content (SC)

The solids content of the aqueous dispersions is measured according to the ISO standard 3251.

b) pH

The pH of the aqueous dispersions is measured according to the ISO standard 976.

### c) Viscosity

The viscosity of the aqueous dispersions is measured according to the ISO standard 2555.

### d) Size of the Particles

The size of the particles is measured by Photon Correlation Spectroscopy (PCS) using an N4+ device from Beckman Coulter. The sample is diluted (3 to 5 drops of emulsion in 50 ml of water) in a polystyrene cell using deionized water through a 0.22 μm cellulose acetate filter. The size of the particles is measured at a temperature of 25° C., under a measurement angle of 90° and at a wavelength of the laser of 633 nm.

### e) Minimum Film-Formation Temperature (MFFT) Measured and Expected as a Function of the Structuring or Nonstructuring of the Particle

The MFFT of the aqueous dispersions is measured according to the ISO standard 2115.

It should be noted that the MFFT expected for a particle perfectly structured as a hard/soft core P1/shell P2 is close (plus or minus as a function also of the % of P2) to the Tg2 (see table 9). When the MFFT is close to the mean Tg, this is a sign that the particle is not structured (mixture of the P1 and P2 phases). More particularly, it may be considered, to a first approximation, that, for a perfectly structured particle having a % P2 exceeding 60%, said MFFT (expected) tends to be coincident with the Tg2 to within the accuracy of measurement of the MFFT (+−2° C.) and of the Tg2 (according to Fox). For a % P2 up to 60%, the expected MFFT varies according to the information presented in table 9.

### f) Mechanical Performance

Tensile Strength:

The tests of tensile strength were carried out on an MTS 1MH tensile testing device, at a temperature of 23° C. and at 50% relative humidity (RH) and with a 50N cell.

The rate of the test is 5 mm/min.

### 5) Preparation of the Coating Formulations (Paints)

### 5.1) Starting Materials (See Table 3 Below)

TABLE 3
Starting materials used in the paint formulations

| Constituent | Role | Chemical nature | Supplier |
|---|---|---|---|
| Acticide^{R} MBS | Biocide | Aqueous solution of | Thor |
| | | methylisothiazoline (MIT) and of | |
| | | benzisothiazolinone (BIT) | |
| Propylene glycol | Solvent | — | Acros |
| AMP 90 | Neutralizing agent | 2-Amino-2-methyl-1-propanol | Angus Chemie |
| Disperbyk^{R} 190 | Dispersing agent | Masked copolymer having a high | Byk Chemie |
| | | molecular weight | |
| Tiona 595 | Pigment | Titanium dioxide | Millenium |
| Aquaflow^{R} NHS | Thickener | Hydrophobically modified | Hercules |
| 300 | | polyacetal-polyether | Aqualon |
| Byk^{R} 022 | Antifoaming agent | Polysiloxane | Byk-Chemie |
| Aqueous | Neutralizing agent | — | VWR |
| ammonia | | | |
| Additol^{R} VXW | Dryer | Combination of cobalt, lithium and | Cytec Surface |
| 6206 | | zirconium carboxylates | Specialties |
| Acrysol^{R} RM-8 | Thickener | HEUR (Hydrophobically modified | Rohm & Haas |
| W | | Ethylene oxide URethane) | |
| | | thickener | |
| Tego^{R} Glide 450 | Glide and flow | Polyether siloxane copolymer | Tego Chemie |
| | additive | | |
| Synaqua^{R} 4804 | Alkyd emulsion | | Cray Valley |

The performances of the aqueous dispersions described in table 2 are evaluated on films applied from gloss paint formulations as described in tables 4 and 5.

### 5.2) Procedure for the Preparation of the Paint Formulations

Manufacture of the Mill Base:

The water and the various constituents are successively introduced with stirring into a receptacle, at high speed in a Disperlux model 2075 disperser, to a fineness <10 μm.

Manufacture of the Paint:

The binder or binders (or the fast-drying alkyd emulsion and/or the aqueous dispersion), the mill base prepared above, the water and the various constituents are successively introduced with stirring into a receptacle.

### 5.3) Composition of the Formulations: Acrylic Paints (Table 4) or Acrylic/Alkyd Paints (Table 5)

TABLE 4
Composition of the acrylic paint formulations

| Constituent | Role | Parts by weight (%) |
|---|---|---|
| Aqueous dispersion | — | 60.63 |
| The mill base is added | | |
| Mill base: | | |
| Water | | 4.00 |
| Acticide^{R} MBS | Biocide | 0.20 |
| Propylene glycol | Solvent | 2.00 |
| AMP 90 | Neutralizing agent | 0.10 |
| Disperbyk^{R} 190 | Dispersing agent | 0.72 |
| Tiona 595 | Pigment | 24.00 |
| Byk^{R} 022 | Antifoaming agent | 0.15 |

The following are added with stirring

| | | |
|---|---|---|
| Water | | 4.72 |
| Aquaflow^{R} NHS 300 | Thickener | 2.56 |
| Acrysol^{R} RM-8 W | Thickener | 0.77 |
| Aqueous ammonia | Neutralizing agent | ~0.20 |
| | | To final pH >8.5 |
| Paint total | | 100 |

### Characteristics of the Formulations (Calculated Using the “PV6FORMULA Version 2-3” Formulation Software of Pierre Vergne—Inter Deposit Digital Number: IDDN.FR.001.280022.001.S.P.2001.000.30265):

Pigment volume concentration: PVC=19%

Solids content by weight=52.3%

Solids content by volume=40%

Density: d=1.26

TABLE 5
Composition of the acrylic/alkyd paint formulations

| Constituent | Role | Parts by weight (%) |
|---|---|---|
| Synaqua^{R} 4804 | Alkyd emulsion | 34.30 |
| Additol^{R} VXW 6206 | Dryer | 0.26 |
| Aqueous dispersion | — | 25.51 |

Mixing is carried out for 5 min and then the mill base is added

| Mill base: | | |
|---|---|---|
| Water | | 5.32 |
| Acticide^{R} MBS | Biocide | 0.19 |
| Disperbyk^{R} 190 | Dispersing agent | 0.60 |
| Tiona 595 | Pigment | 24.00 |
| Byk^{R} 022 | Antifoaming agent | 0.19 |
| The following are added with stirring | | |
| Water | | 4.11 |
| Tego^{R} Glide 450 | Glide and flow additive | 0.03 |
| Aquaflow^{R} NHS 300 | Thickener | 2.53 |
| Acrysol^{R} RM-8 W | Thickener | 2.98 |
| Paint total | | 100 |

### Characteristics of the Formulations (Calculated Using the “PV6FORMULA Version 2-3” Formulation Software of Pierre Vergne—Inter Deposit Digital Number: IDDN.FR.001.280022.001.S.P.2001.000.30265):

Pigment volume concentration: PVC=19%

Solids content by weight=54.1%

Solids content by volume=41%

Density: d=1.28

### 6) Performances Measured and Methods Used

a) Viscosity
The viscosities of the paints are measured using a CAP 1000 high shear gradient viscometer at 25° C. and at 10 000 s⁻¹ (according to the ISO standard 2884) and using a low shear gradient Brookfield viscometer at 10 rpm (according to the ISO standard 2555).

b) pH
The pH of the paint formulations is measured according to the ISO standard 976.

c) Gloss
The measurements are carried out using a “Micro-TRI-gloss” glossmeter from BYK Gardner GmbH under angles of 20° and 60°, after drying at 23° C.±1° C. and at 50%±5% RH for 24 hours, on nonformulated films of aqueous dispersions with a thickness of 150 μm deposited on Leneta 2A charts and on paint films with a thickness of 200 μm deposited on glass plates, according to the ISO standard 2813.

d) Hardness
The hardness is evaluated using a Persoz hardness pendulum on wet films with a thickness of 100 μm applied to glass plates, after drying for 14 days (at 23° C.±1° C. and at 50%±5% RH), according to the ISO standard 1522.

e) Resistance to Blocking
The paints to be evaluated are applied to two Leneta 2A charts at a chosen thickness using a film applicator. These paints are stored in a climate-controlled chamber (at 23° C.±1° C. and at 50%±5% RH) for a predetermined time. The painted faces of these charts are subsequently placed face to face between 2 glass dates. The assembly is compressed by a weight which makes it possible to obtain a pressure of 50 g/cm² over the entire test surface. The painted faces are left in contact in a climate-controlled chamber for a predetermined time. At the end of the contact time, the charts are gently separated by pulling on the 2 charts, in all directions.

The damage caused on the paint films is then quantified on a scale varying from 0 to 8 according to the instructions given in table 6 below:

TABLE 6
Scale of evaluation of the resistance to blocking

| | |
|---|---|
| 0 | No adhesion between the films and no noise during the separation |
| | of the charts |
| 1 | Detachment of the films with a slight noise but without a |
| | detrimental change in the test surface |
| 2 | Tearing < 10 points on the test surface |
| 3 | Tearing < 50 points on the test surface |
| 4 | Tearing > 50 points on the test surface |
| 5 | Tearing of the surface < 20% of the test surface |
| 6 | Tearing of the surface between 20 and 50% of the test surface |
| 7 | Tearing of the surface > 50% of the test surface |
| 8 | Complete tearing of the test surface |

The thicknesses, drying times and contact times chosen are as follows: −200 μm wet/drying time of 24 hours at 23° C.±1° C., 50%±5% RH/contact time of 24 hours at 23° C.±1° C., 50%±5% RH.

f) Resistance to Water
Wet films with a thickness of 200 μm are applied to glass plates and then dried for 7 days in a climate-controlled chamber (23° C.+/−1° C. and 50%+/−5% RH).

Drops of water are subsequently deposited for a predetermined time (15 minutes and 30 minutes) at the surface of the paint films and the damage caused is evaluated, before drying and after drying for 24 hours, on a scale varying from 0 to 4 according to the instructions given in table 7 below:

TABLE 7
Evaluation of the resistance to water

| | |
|---|---|
| 0 | Partial or complete destruction of the paint film |
| 1 | Intense blistering of the paint film |
| 2 | Blistering of the paint film visible to the naked eye |
| 3 | Trace barely visible to the naked eye (microblistering, swelling, |
| | and the like) |
| 4 | No detrimental change in the paint film |

g) Resistance to Staining

The resistance to household stains is tested on the paints applied at 200 μm wet to Leneta P121-10N PVC sheets after drying for a week. The stains are in contact with the test paint for 15 min, according to the model below. Grading is carried out according to the standard NF EN 12720 after cleaning off the stain using a dilute Teepol solution. This grading takes into account losses in gloss, variations in coloring or modifications to the structure of the paint film tested:
5—No visible change (no damage).
4—Slight change in gloss or in color, visible solely when the light source is reflected on the test surface or very close to the point examined, and is returned to the eye of the observer, or a few isolated marks which are barely visible.
3—Slight mark, visible under several angles of observation.
2—Pronounced mark, the structure of the surface being however, virtually unchanged.
1—Pronounced mark, the structure of the surface being modified, or else the material being completely or partially removed.
   The stains tested are based on: red wine, coffee or blue ink.

h) Flexibility Test
Two layers of paint (drying between coats of 24 hours) are deposited at a rate of 10 m²/l on a pine angle piece with a length of 12 cm according to the following scheme:
After drying for a week in a climate-controlled chamber (at 23° C.+/−1° C. and 50%+/−5% RH), the test specimens are subjected to 5 freezing/thawing cycles (freezing: immersion in water in a freezer for 16 hours/thawing: 8 hours in a climate-controlled chamber after removing the ice formed under running water).

The surface defects (cracking/blistering) are graded at the end of each cycle on a scale varying from 0 to 10 as indicated in table 8 below:

TABLE 8
Scale of evaluation according to the flexibility test

| Cracking | | Blistering | | |
|---|---|---|---|---|
| Grade | Density | Grade | Density | Mean size |
| 10 | No cracking | 5 | None | No blistering |
| 8 | Slight | 4 | <2 blisters | <2 mm |
| 6 | Moderate | 3 | <5 blisters | <5 mm |
| 4 | Pronounced | 2 | <7 blisters | <7 mm |
| 2 | Severe | 1 | <10 blisters | <10 mm |
| 0 | Total | 0 | >10 blisters | >10 mm |

The grade corresponding to blistering corresponds to the grade of the density+the grade of the mean size of blistering.

### B) Results of Characterization and Comparisons

### 1) MFFT and Film Formation

In order to judge the management of the targeted structure of the particles during the preparation of the dispersions according to the invention, the following significant criteria were used:
MFFT: it is obtained without a coalescence agent and corresponds perfectly to that which is expected as a consequence of the hard/soft core P1/shell P2 structure actually controlled. An estimation of the value of the expected MFFT as a function of the thickness of the shell (% P2) and of its Tg (Tg2) is given in table 9. The estimated value for MFFT results from an estimation from the correlation of measured MFFT values as a function of Tg2, for different % of P2 for structured particles, as mentioned.
The prediction according to the data of table 9 is more preferably confirmed when, for a % of P1>35%, the Tg1 remains below 75° C.

TABLE 9
Expected MFFT, estimated as a function
of the characteristics of the shell

% P2

| Tg2 | 55% | 60% | 72% |
|---|---|---|---|
| −15° C. | 0 to 5° C. | 0 to 5° C. | <0° C. |
| −10° C. | 5 to 10° C. | 0 to 5° C. | <0° C. |
| −5° C. | 10 to 15° C. | 5 to 10° C. | <2° C. |
| 0° C. | 15 to 20° C. | 10 to 15° C. | 0 to 5° C. |
| 5° C. | 20 to 25° C. | 15 to 20° C. | 5 to 10° C. |

The Tg2 values are calculated according to Fox law, as already explained above for the Tg values.
The film formation: It is excellent, without a coalescence agent; the film is completely transparent (homogeneous and free from defects).
   The term “transparent” is understood to mean that a wet film of 200 μm applied to a glass plate is homogeneous and free from defects under drying conditions at a temperature varying between 5 and 25° C. The humidity conditions are between 25 and 75% and adapted to the film formation temperature: the lower the temperature, the greater the humidity. Under such conditions, the “mud cracking” phenomenon, poorly controlled surface drying kinetics, does not concern this type of film.

These characteristics are given for each dispersion in table 10 below:

TABLE 10
Film formation characterization of the dispersions of tests 1 to 7

| | | | Expected MFFT | | | | |
|---|---|---|---|---|---|---|---|
| | | Measured | vs core P1/ | | | | |
| | | MFFT | shell P2 structured | | | Mean Tg | Quality of |
| | Comments | (° C.) | particle (° C.) | % P2 | Tg2(° C.) | (° C.) | the film |
| 1 | According to | 5 | 0-5 | 72 | 0 | 18 | Transparent |
| | the invention | | | | | | |
| 2 | According to | 2 | 0-5 | 60 | −15 | 12 | Transparent |
| | the invention | | | | | | |
| 3 | Comparative | 11 | 0-5 | 72 | 0 | 18 | Haze |
| | P1 without M1 | | | | | | |
| 4 | Comparative | 16 | 0-5 | 72 | 0 | 18 | Transparent |
| | P1 without M2 | | | | | | |
| 5 | Comparative | 16 | 0-5 | 72 | 0 | 18 | Haze |
| | P1 without M1 | | | | | | |
| | and M2 | | | | | | |
| 6 | According to | 5 | 0-5 | 60 | −10 | 17 | Transparent |
| | the invention | | | | | | |
| 7 | According to | 2 | 0-5 | 60 | −10 | 17 | Transparent |
| | the invention, | | | | | | |
| | with M5 effect | | | | | | |
| | (addition of | | | | | | |
| | Radia 7061 to | | | | | | |
| | P2) | | | | | | |

Only the films coming under the invention are transparent (homogeneous and free from defects) and with an experimental MFFT within the expected MFFT range according to the data of table 9. The tests outside the invention result in hazy films and/or films exhibiting a higher MFFT than that expected and closer to the mean Tg according to Fox (of P1 and P2), which would correspond here, in such a case, to an at least partial loss of the structure of the particles obtained. These results are shown in table 11 below:

TABLE 11
Comparison between the measured MFFT and the expected MFFT
11-a) Tests according to the invention:

| | Test ref. | 1 | 2 | 6 | 7 |
|---|---|---|---|---|---|
| | % P2 | 72 | 60 | 60 | 60 |
| Fox | Tg1 P1 (° C.) | 79 | 64 | 71 | 71 |
| Tg | Tg2 P2 (° C.) | 0 | −15 | −10 | −10 |
| | Mean Tg | 18 | 12 | 17 | 17 |
| | Measured | 5 | 2 | 5 | 2 |
| | MFFT (° C.) | | | | |

11-b) Tests outside the invention:

| | Test ref. | 3 | 4 | 5 |
|---|---|---|---|---|
| | % P2 | 72 | 72 | 72 |
| Fox | Tg1 P1 (° C.) | 79 | 79 | 79 |
| Tg | Tg2 P2 (° C.) | 0 | 0 | 0 |
| | Mean Tg | 18 | 18 | 18 |
| | Measured | 11 | 16 | 16 |
| | MFFT (° C.) | | | |

### 2) Stability Performance of the Dispersion According to the Invention

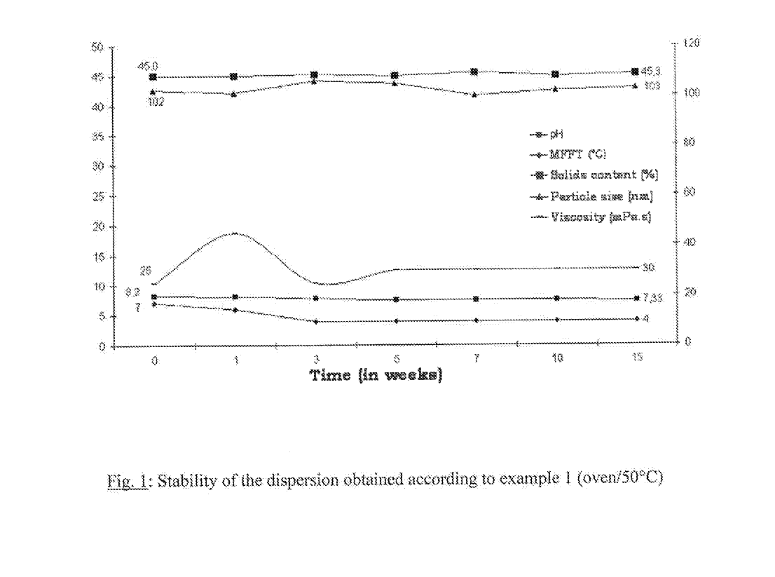

The monitoring over time of the characteristics, such as viscosity, pH, solids content and particle size, of the dispersion of example 1, placed in an oven at 50° C., has made it possible to demonstrate that all the characteristics of the dispersion obtained according to the invention are completely stable. Remarkably, the MFFT is stable after testing at 50° C. for 15 weeks (see FIG. 1). This characteristic was reproduced exactly over all the tests coming under the invention.

3) Results with Regard to Acrylic Paint Formulations (Table 12)

The thickness of the paint film and its method of application vary according to the test desired.

For each measurement, reference is made to the corresponding test method in sections A, 4 to 6.

TABLE 12
Results with regard to acrylic paints

| | | Dispersion used according to | | |
|---|---|---|---|---|
| | | example (table 2) | | |
| | | 1 | 6 | 7 |
| VOC (g/l) | | <30 | <30 | <30 |
| Brookfield | 1 day | 6060 | 3310 | 3640 |
| viscosity at | 15 days at 23° C. | 9000 | 3600 | 4250 |
| 10 rpm | | | | |
| (mPa · s) | | | | |
| CAP 1000 | 1 day | 178 | 225 | 166 |
| viscosity at | 15 days at 23° C. | 208 | 229 | 222 |
| 25° C. and at | | | | |
| 10 000 s⁻¹ | | | | |
| (mPa · s) | | | | |

| | | | |
|---|---|---|---|
| pH at the end of manufacture | 8.8 | 8.7 | 8.7 |

The VOC values (in g/l) are calculated using the “PV6FORMULA, Version 2-3” formulation software as described above.

The viscosity measurements show that the paint formulations exhibit good stability on storage.

4) Results with Regard to Acrylic/Alkyd Paints, Based on Mixtures of the Alkyd Dispersions with the Polymer Dispersions According to Examples 1 and 7

The preparation of the acrylic/alkyd paints is described in section A 5, and more particularly 5.3, table 5.

TABLE 13
Results with regard to acrylic/alkyd paints

| | | Polymer dispersion according | |
|---|---|---|---|
| | | to the example indicated + | |
| | | Synaqua 4804 | |
| | | 1 | 7 |
| VOC (g/l) | | <30 | <30 |
| Brookfield | 1 day | 7040 | 13 000 |
| viscosity at | 15 days at 23° C. | 8930 | 16 600 |
| 10 rpm | | | |
| (mPa · s) | | | |
| CAP 1000 | 1 day | 335 | 357 |
| viscosity at | 15 days at 23° C. | 313 | 336 |
| 25° C. and at | | | |
| 10 000 s⁻¹ | | | |
| (mPa · s) | | | |

The VOC values (in g/l) are calculated using the “PV6FORMULA, Version 2-3” formulation software, as described above.

### 5) Performances of the Films of Polymer Dispersions (Emulsions) and of the Corresponding Acrylic Paints

TABLE 14
Performances of the films of emulsion and of acrylic paint

| | | | Polymer |
|---|---|---|---|
| | | | dispersion |
| | | | according to |
| | | | example |
| | | | 1 |
| Emulsion film | Tensile strength | Elongation at | 121 |
| | | break (%) | (11%) |
| | | Breaking stress | 14.3 |
| | | (MPa) | (7.9%)* |
| | | Young's | 145 |
| | | modulus | (6.7%) |
| | | (MPa) | |
| Paint film | Gloss | 20° | 49 |
| | | 60° | 80 |
| | Flexibility test | Before the test | 10/10 |
| | Cracking/Blistering | After 1^{st} cycle | 10/10 |
| | | 2^{nd} cycle | 10/10 |
| | | 3^{rd} cycle | 10/10 |
| | | 4^{th} cycle | 9/10 |
| | | 5^{th} cycle | 9/10 |

*The values given in brackets correspond to the percentage of standard deviation.

The mechanical properties of the emulsion films and the test of flexibility of the paint film make it possible to evaluate the flexibility and the cohesion of the coating obtained.

Example 1 according to the invention exhibits a high elongation at break and a high breaking stress: these results show that the film obtained from example 1 is flexible and cohesive. These observations are confirmed by the very good results obtained by the flexibility test: the example according to the invention makes it possible to obtain a very stable coating as the freezing/thawing cycles progress.

### 6) Influence of the Presence of the Monomer M5 on the Performances of the Films of Acrylic Paints

TABLE 15
Performances of the films of the acrylic paints

| | | With dispersion | | |
|---|---|---|---|---|
| | | according to example | | |
| | | 1 | 6 | 7 |
| Gloss | 20° | 49 | 53 | 50 |
| | 60° | 80 | 77 | 77 |
| Persoz hardness (s) | After 24 hours | 117 | 106 | 81 |
| | After 7 days | 124 | 144 | 95 |
| Resistance to blocking | After drying for 24 h + | 1 | 1 | 1 |
| | contact at 23° C. for 24 h | | | |
| | After drying for 48 h + | 2 | 4 | 1 |
| | contact at 50° C. for 1 h | | | |
| Resistance to water | After 15 min | 1/3 | 1/3 | 1/3 |
| before drying/after | After 30 min | 1/3 | 1/3 | 1/3 |
| drying for 24 h | | | | |
| Resistance to staining | Red wine | 2 | 3 | 3 |
| after 15 min | Coffee | 3 | 2 | 2 |
| | Blue ink | 2 | 2 | 2 |

The results presented in table 15 show a very good compromise in properties in terms of gloss, hardness, resistance to blocking, resistance to water and resistance to stains.

The resistance to blocking of the two tests is excellent after drying for 24 hours and contact at 23° C. for 24 hours. A difference is noted when the test is carried out under more critical conditions, after drying for 48 hours and contact at 50° C. for 1 hour. In the latter case, it is observed that the addition of the methyl ester of linseed oil in example 7 makes it possible to markedly improve the resistance to blocking.

### 7) Influence of the Presence of the Monomer M5 on the Performances of the Films of Acrylic/Alkyd Paints

TABLE 16
Performances of the films of the acrylic/alkyd paints

| | | Formulation with | |
|---|---|---|---|
| | | dispersion according | |
| | | to the example cited | |
| | | Alkyd dispersion | |
| | | Synaqua 4804 | |
| | | 6 | 7 |
| Gloss | 20° | 59 | 65 |
| | 60° | 100 | 90 |
| Persoz hardness (s) | After 24 hours | 97 | 91 |
| | After 7 days | 164 | 142 |
| Resistance lo blocking | After drying for 24 h + | 1 | 1 |
| | contact at 23° C. for 24 h | | |
| Resistance to water | After 15 min | 3/4 | 3/4 |
| before drying/after | After 30 min | 3/4 | 3/4 |
| drying for 24 h | | | |

The acrylic dispersions obtained according to the invention exhibit a very good compatibility with the alkyds. The results present in table 16 show that the mixture makes it possible to significantly improve the gloss of the film and the resistance to water, and results in a very good level of hardness after 7 days. Furthermore, the resistance to blocking of the two formulations remains identical and excellent.

1) An aqueous polymer dispersion comprising particles structured as a hard/soft core/shell, characterized in that:
the polymer phase of the core P1 has a glass transition temperature Tg1 from 60 to 120° C., and
the polymer phase of the shell P2 has a glass transition temperature Tg2 from −20 to 40° C., and that
said dispersion exhibits a minimum film-formation temperature MFFT from 0 to 50° C.
the phase P1 represents from 15 to 60% by weight with respect to the total weight of monomers of said dispersion, and
the phase P1 comprises at least one monomer M1 having at least two copolymerizable ethylenic unsaturations (having a cross linking agent role) and at least one ethylenically unsaturated monomer M2 carrying at least one carboxylic acid and/or anhydride functional group,
the phase P2 represents from 40 to 85% by weight of the total of the monomers of said dispersion, and
in that said phase P2 comprises:
at least one monomer M3 selected from the monomers carrying, in addition to the polymerizable ethylenic unsaturation, at least one group selected from the group consisting of acetoacetoxy, diacetone, methylol, alkoxysilane, diacetone acrylamide (DAAM), N-methylolacrylamide (NMA), acetoacetoxyethyl methacrylate (AAEM) and alkoxysilyl(meth)acrylates.

2) The dispersion as claimed in claim 1, characterized in that said phase P2 additionally comprises at least one transfer agent selected from hydrophilic mercaptans (or mercaptans carrying an ionic group).

3) The dispersion as claimed in claim 1, characterized in that said dispersion comprises, in the dispersed state, at least one polyamine having at least two amine functional groups in the case where said monomer M3 carries an acetoacetoxy group and at least one C₄ to C₈ compound carrying at least two hydrazide functional groups in the case where said monomer M3 carries a diacetone group.

4) The dispersion as claimed in claim 1, characterized in that said phase P1 is composed of a seed polymer phase P0 and of a complementary polymer phase P′1 and that the composition of said phase P0 is devoid of said monomers M1 and M2 and that, with regard to the remainder, the compositions of P0 and P′1 are identical or different.

5) The dispersion as claimed in claim 1, characterized in that said phase P2 comprises at least one second transfer agent selected from hydrophobic mercaptans with a ratio by weight of hydrophilic agent to hydrophobic agent of greater than 1.

6) The dispersion as claimed in claim 5, characterized in that the overall content of said first and second transfer agents represents, by weight, from 0.02 to 2% and preferably from 0.05 to 1.5%, with respect to the total weight of the monomers of said dispersion (phases P1+P2).

7) The dispersion as claimed in claim 1, characterized in that, for a content by weight of P1 exceeding 35%, said Tg1 remains below 75° C.

8) The dispersion as claimed in claim 1, characterized in that the difference between said Tg1 and Tg2 values varies from 20 to 140° C.

9) The dispersion as claimed in claim 1, characterized in that the monomer M1 of the phase P1 is chosen from monofunctional or polyfunctional allyl ester monomers derived from α,β-unsaturated carboxylic or dicarboxylic acids or polyfunctional ally! esters of saturated di- or polycarboxylic acids or other polyallyl monomers, polyfunctional (meth)acrylic esters with a functionality of at least 2 and polyvinylbenzenes.

10) The dispersion as claimed in claim 1, characterized in that said monomer M2 of the phase P1 is chosen from (meth)acrylic, fumaric, maleic, itaconic, vinylbenzoic, crotonic or isocrotonic acids and/or their anhydrides and preferably methacrylic acid and/or acrylic acid.

11) The dispersion as claimed in claim 1, characterized in that said monomers M1 and M2 of the phase P1 represent an overall content by weight ranging from 0.5 to 10% of the total weight of the phase P I with said monomer M2 representing from 0.1 to 5% by weight of said phase P1.

12) The dispersion as claimed in claim 1, characterized in that the phase P2 also comprises at least one monomer M2 as defined in claim 1 or 7, with respective contents by weight of M2 in the phases P1 and P2 chosen so that the ratio of the content by weight of M2 in P1 to that in P2 varies from 1/1 to 1/10.

13) The dispersion as claimed in claim 1, characterized in that said monomer M3 is present in said phase P2 at a content by weight of 1 to 25%, expressed with respect to the total weight of P1+P2, and with a percentage, expressed with respect to P2, ranging from 1 to 60% and preferably from 1.5 to 40%.

14) The dispersion as claimed in claim 1, characterized in that said monomer M3 carries an acetoacetoxy group quantitatively converted into the enamine group masked form in situ during the polymerization corresponding to phase P2 and in that, in this case, said phase P2 is devoid of any monomer M2 as defined in claims 1 or 10.

15) The dispersion as claimed in claim 1, characterized in that said phase P1 also comprises at least one monomer M2 carrying an acetoacetoxy group.

16) The dispersion as claimed in claim 15, characterized in that said acetoacetoxy group of the phase P1 is quantitatively converted into the enamine masked form during the polymerization corresponding to the phase P2.

17) The dispersion as claimed in claim 1, characterized in that said phase P2 additionally comprises at least one monomer M4 carrying, in addition to the polymerizable ethylenic unsaturation, at least one functional group selected from: hydroxyl, amine, oxirane, phosphates, phosphonates or phosphinates, amide, sulfate or sulfonate, imide, aziridine, oxazoline or imidazole, provided that the choice of the monomers M4 is made so as to avoid a reaction between the various groups of the monomers M4 or between the groups of the monomers M4 and the groups of the other monomers.

18) The dispersion as claimed in claim 1, characterized in that said phase P2 additionally comprises at least one monomer M5 selected from at least one oil (glycerol esters) of unsaturated C₁₀ to C₃₆ fatty acids and/or methyl esters corresponding to these acids.

19) The dispersion as claimed in claim 1, characterized in that said phase P2 comprises both the monomer M3 under the conditions as defined in claim 13 and the monomer M5 as defined in claims 18.

20)-27) (canceled)

28) A process for the preparation of a dispersion as defined in claim 1, characterized in that it comprises at least the three following stages:
i) preparing a prepolymerization of a seed composition P0 devoid of monomers M1 and M2 and with seed particles having a size of less than or equal to 30 nm, and representing a content by weight ranging from 2 to 25% of the weight of said phase P1 (seeding stage),
ii) polymerizing a monomer composition P′1 comprising said monomers M1 and M2 and giving the polymer phase P′1, thus constituting, with the seed polymer P0 obtained in stage i), said polymer phase P1 of said particle core, it being possible for said monomer composition P′1, apart from the presence of the monomers M1 and M2, to be identical to or different from that of said seed composition P0,
iii) polymerizing a monomer composition P2, giving rise to said phase P2.

29) The process as claimed in claim 28, characterized in that:
the seeding stage i) is carried out in the presence of from 0.1 to 1.5% by weight of the total weight of P1+P2 of at least one anionic surfactant,
the stage ii) of polymerization of the monomer composition P′1 is carried out in the presence of from 0.1 to 3% by weight of the total weight of P1+P2 of at least one anionic surfactant, which can be the same as or different from that of the seed P0, and of a second anionic surfactant different from the first, with the content by weight of these two anionic surfactants of P1 remaining between 0.1 and 3%, of the total weight of P1+P2,
the stage iii) of polymerization of the monomer composition P2 is carried out in the presence of from 0.1 to 3% by weight of P1+P2 of at least two surfactants:
a) the first being nonionic and chosen from alkoxylated fatty alcohols, the number of said alkoxy units preferably being from 3 to 50.
b) the second being anionic and being able to be identical to or different from that defined for P0.

30) The process as claimed in claim 28, characterized in that:
stages i) and ii) are carried out at a temperature of 75 to 90° C.,
the stage iii) of polymerization of said monomer composition P2 is carried out at a temperature below Tg1, when said process is carried out at atmospheric pressure.

31) The process as claimed in claim 28, characterized in that the stage ii) of emulsion polymerization of the monomer composition P′1 is continued up to a degree of conversion of at least 95%, before addition of the monomer composition P2.

32) An aqueous polymer dispersion, characterized in that it comprises at least one aqueous polymer dispersion as defined in claim 1 and that it additionally comprises at least one other second aqueous polymer dispersion.

33) The dispersion as claimed in claim 32, characterized in that said second aqueous polymer dispersion is based on at least one modified or unmodified alkyd resin.

34) The aqueous dispersion as claimed in claim 33, characterized in that the content by weight of said alkyd resin represents from 15 to 45% of the alkyd+polymer (alkyd+P1+P2) total of the dispersion as defined in claim 1.

35) The aqueous dispersion as claimed in claim 33, characterized in that said aqueous dispersion comprises, as polymer dispersion, at least one aqueous dispersion wherein said phase P2 additionally comprises at least one monomer M5 selected from at least one oil (glycerol esters) of unsaturated C₁₀ to C₃₆ fatty acids and/or methyl esters corresponding to these acids.

36) (canceled)

37) A coating or treatment composition, characterized in that it comprises at least one aqueous dispersion as defined in claim 1.

38) The coating composition as claimed in claim 37, characterized in that it is a protective and/or decorative coating composition selected from paints, varnishes, transparent coatings, inks or adhesives.

39) The composition as claimed in claim 38, characterized in that it is a composition for the treatment of fibers.

40-42. (canceled)

43) A coating, characterized in that it is obtained by the use of at least one dispersion as defined in claim 1.

44) A coated substrate, characterized in that it is coated with at least one layer of at least one coating composition as defined in claim 37.

45) A treated fiber, characterized in that it is treated with at least one treatment composition as defined in claim 39.
